(19) United States
(12) Patent Application Publication
(10) Pub. No.: US 2008/0010423 A1
(43) Pub. Date: Jan. 10, 2008

(54) NETWORK DEVICE AND TIME SYNCHRONIZATION METHOD THEREOF

(75) Inventor: CHU-FENG LIEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/617,753

(22) Filed: Dec. 29, 2006

(30) Foreign Application Priority Data
May 5, 2006 (TW) 95115997

(51) Int. Cl. G06F 13/28; G06F 13/00; G06F 12/00

(52) U.S. Cl. 711/162

(57) ABSTRACT

A network device is provided, the network device connected to a local exchange, and comprising a main interface system, a backup interface system, and a management system. The main interface system comprises a main transceiving module that receives an instruction from the local exchange, and transmits time information in the main interface system to the backup interface system. The backup interface system comprises a backup transceiving module, a backup counting module, and a backup starting module. The backup transceiving module determines whether a replacement message is received from the management system, and transmits an acknowledgement message to the local exchange if the replacement message is received. The backup counting module counts time from receiving the instruction from the local exchange to transmitting the acknowledgement message thereto. The backup starting module starts the backup counting module according to counted time. A time synchronization method is also provided.

### BACKGROUND OF THE INVENTION

1. Field of the Invention

The invention generally relates to a device and method, and particularly to a network device and time synchronization method thereof.

2. Description of Related Art

In a typical public switching telephony network, a client is connected to a local exchange (LE) via an access network device including a main V5 interface system, a backup V5 interface system, and a management system. In case that a main V5 interface system operates normally, the LE may manage the access network device via the main V5 interface. When the main V5 interface fails, the backup V5 interface is used to replace the main V5 interface. However, due to a fact that the backup V5 interface may not receive any message from the main V5 interface about any ongoing connection or call, it probably fails to send an acknowledgement message to the LE to maintain this ongoing connection or call, a communication failure may take place between the LE and the backup V5 interface.

Therefore, a heretofore unaddressed need exists in the industry to overcome the aforementioned deficiencies and inadequacies.

### SUMMARY OF THE INVENTION

A network device is provided, the network device connected to a local exchange, and comprising a main interface system, a backup interface system, and a management system. The main interface system comprises a main transceiving module that receives an instruction from the local exchange, and transmits time information in the main interface system to the backup interface system. The backup interface system comprises a backup transceiving module, a backup counting module, and a backup starting module. The backup transceiving module determines whether a replacement message is received from the management system, and transmits an acknowledgement message to the local exchange if the replacement message is received. The backup counting module counts time from receiving the instruction from the local exchange to transmitting the acknowledgement message thereto. The backup starting module starts the backup counting module according to counted time. The management system replaces a failed main interface system with the backup interface system, and transmits the replacement information to the backup interface system.

A time synchronization method is also provided, the time synchronization method applicable to a network device connected to a local exchange, and comprising: providing a management system, a main transceiving module, a main starting module, a main counting module, a backup transceiving module, a backup starting module, and a backup counting module; receiving an instruction from the local exchange by the main transceiving module; starting of the main counting module by the main starting module; transmitting time information in the main counting module to the backup counting module by the main transceiving module; starting of the backup counting module according to the time information by the backup counting module; determining whether the backup counting module has timed out; determining whether a replacement message is received from the management system by the backup transceiving module if the backup counting module has timed out; and transmitting an acknowledgement message to the local exchange by the backup transceiving module if a replacement message is received from the management system.

Other advantages and novel features will become more apparent from the following detailed description when taken in conjunction with the accompanying drawings, in which:

### BRIEF DESCRIPTION OF THE DRAWINGS

FIG. 1 is a schematic diagram illustrating an application environment of a network device of an exemplary embodiment of the invention;

FIG. 2 is a block diagram of the network device of an exemplary embodiment of the invention; and

FIG. 3 is a flowchart of a time synchronization method of another exemplary embodiment of the invention.

### DETAILED DESCRIPTION OF THE INVENTION

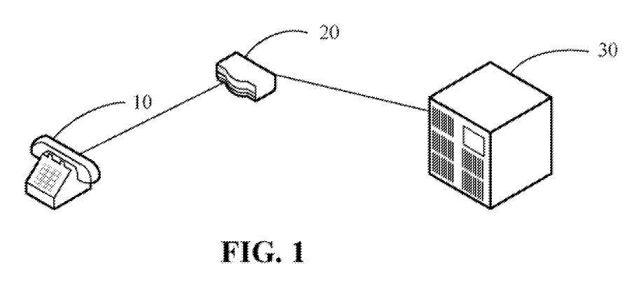

FIG. 1 is a schematic diagram illustrating an application environment of a network device 20 of an exemplary embodiment of the invention. The network device is connected between a client 10 and a local exchange (LE) 30, and the LE 30 may manage the network device 20 via a V5 interface. In this embodiment, the client 10 may be a telephone, and the network device may be an access network (AN) device.

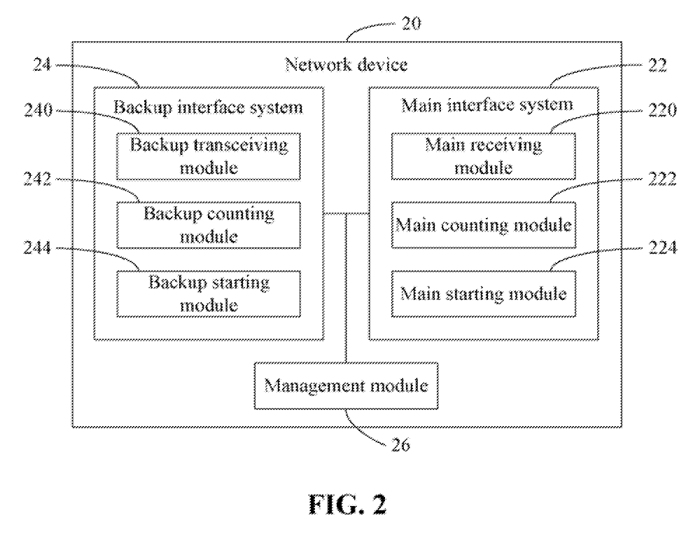

FIG. 2 is a block diagram of the network device 20 of an exemplary embodiment of the invention. The network device 20 includes a main interface system 22, a backup interface system 24, and a management system 26.

The main interface system 22 includes a main transceiving module 220, a main counting module 222, and a main starting module 224.

The main transceiving module 220 receives an instruction from the LE 30, and transmits time information in the main interface system 22 to the backup interface system 24. In this embodiment, the instruction includes a ringing tone instruction and a polarity inversion instruction. The LE 30 may utilize the ringing tone instruction to establish a connection between a calling party and the client 10, and the polarity inversion instruction to measure connection time between the calling party and the client 10.

The main counting module 222 counts time from receiving the instruction from the LE 30 to transmitting an acknowledgement message thereto. In this embodiment, the counted time is no more than 5 seconds.

The main starting module 224 starts the main counting module 222 as the main transceiving module 220 receives the instruction from the LE 30.

The backup interface system 24 includes a backup transceiving module 240, a backup counting module 242 and a backup starting module 244.

The backup transceiving module 240 determining whether a replacement message is received from the management system 26, and transmits the acknowledgement message to the LE 30 if the replacement message is received.

The backup counting module 242 counts time from receiving the instruction from the LE 30 to transmitting the acknowledgement message thereto.

The backup starting module 244 starts the backup counting module 242 according to counted time.

The management module 26 replaces a failed main interface system 22 with the backup interface system 24, and transmits the replacement message to the backup interface system 24.

In this embodiment, when the main interface system 22 operates normally, the backup interface system 24 does not operate. If the management system 26 detects that the main interface system 22 has failed, the management system 26 replaces the failed main interface system 22 with the backup interface system 24, and the backup interface system 24 starts operating.

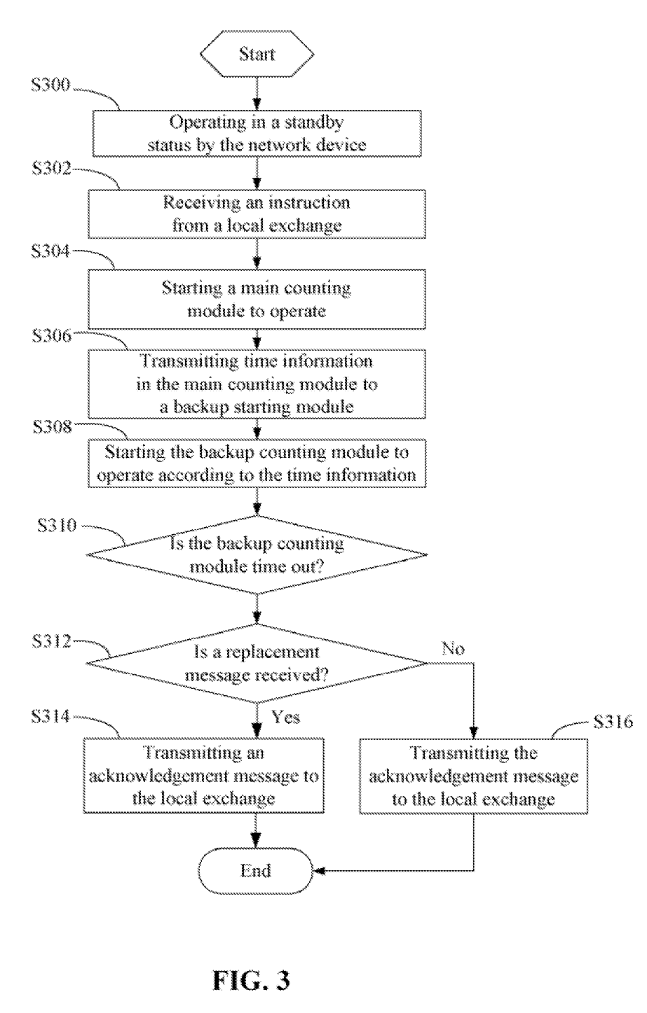

FIG. 3 is a flowchart of a time synchronization method of another exemplary embodiment of the invention.

In step S300, the network device 20 operates in a standby status.

In step S302, the main transceiving module 220 receives an instruction from the LE 30. In this embodiment, the instruction includes a ringing tone instruction and a polarity inversion instruction. The LE 30 may utilize the ringing tone instruction to establish a connection between a calling party and the client 10, and the polarity inversion instruction to measure the connection time between the calling party and the client 10.

In step S304, the main starting module 224 starts the main counting module 222.

In step S306, the main transceiving module 220 transmits time information in the main counting module 222 to the backup starting module 244.

In step S308, the backup starting module 244 starts the backup counting module 242 according to the time information.

In step S310, the backup counting module 242 determines whether the backup counting module 242 has timed out, if the backup counting module 242 has timed out, the process proceeds to step S312, otherwise the process returns to step S308.

In step S312, the backup transceiving module 240 determines whether a replacement message is received from the management system 26. If the replacement message is received from the management system 26, the process proceeds to step S314, otherwise the process proceeds to step S316.

In step S314, the backup transceiving module 240 transmits an acknowledgement message to the LE 30.

In step S316, the main transceiving module 220 transmits the acknowledgement message to the LE 30.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A network device connected to a local exchange, and comprising a main interface system, a backup interface system, and a management system, wherein
the main interface system comprises a main transceiving module for receiving an instruction from the local exchange, and for transmitting time information in the main interface system to the backup interface system;
the backup interface system comprises:
a backup transceiving module for determining whether a replacement message is received from the management system, and for transmitting an acknowledgement message to the local exchange if the replacement message is received;
a backup counting module for counting time from receiving the instruction from the local exchange to transmitting the acknowledgement message thereto; and
a backup starting module for starting the backup counting module according to counted time;
the management system replaces a failed main interface system with the backup interface system, and transmits the replacement information to the backup interface system.

2. The network device in accordance with claim 1, wherein the main interface system and the backup interface system comply with the V5 protocol.

3. The network device in accordance with claim 1, wherein the instruction comprises a ringing tone instruction.

4. The network device in accordance with claim 3, wherein the instruction further comprises a polarity inversion instruction.

5. The network device in accordance with claim 1, wherein the main interface system further comprises a main starting module for starting the main counting module as the main transceiving module receives the instruction from the local exchange.

6. The network device in accordance with claim 1, wherein the main interface system further comprises a main counting module for counting time from receiving the instruction from the local exchange to transmitting the acknowledgement message thereto.

7. A time synchronization method applicable to a network device connected to a local exchange, comprising:
providing a management system, a main transceiving module, a main starting module, a main counting module, a backup transceiving module, a backup starting module, and a backup counting module;
receiving an instruction from the local exchange by the main transceiving module;
starting of the main counting module by the main starting module;
transmitting time information in the main counting module to the backup counting module by the main transceiving module;
starting of the backup counting module according to the time information by the backup counting module;
determining whether the backup counting module has timed out;
determining whether a replacement message is received from the management system by the backup transceiving module if the backup counting module has timed out; and
transmitting an acknowledgement message to the local exchange by the backup tranceiving module if a replacement message is received from the management system.

8. The time synchronization method in accordance with claim 7, further comprising starting of the main counting module by the main starting module as the main transceiving module receives the instruction from the local exchange.

9. The time synchronization method in accordance with claim 7, wherein the management system replaces the main interface system with the backup interface system, and transmits a replacement message to the backup interface system if the main interface system fails.

10. The time synchronization method in accordance with claim 7, wherein the main counting module and the backup counting module count synchronously.

11. The time synchronization method in accordance with claim 7, wherein a time period of the main counting module and the backup counting module is 5 seconds.

12. The time synchronization method in accordance with claim 7, further comprising transmitting an acknowledgement message to the local exchange by the main transceiving module if a replacement message is not received from the local exchange.

13. A method to maintain connective communication between a network device and a local exchange, comprising steps of:
receiving, in a network device which has a main interface system and a backup interface system able to take over and function when said main interface system fails, an instruction from a local exchange signal-communicable with said network device;
starting a main counting module of said main interface system for timing in response to said instruction;
transmitting timing information of said main counting module to a backup counting module of said backup interface system; and
starting said backup counting module of said backup interface system for timing synchronously with said main counting module according to said transmitted timing information of said main counting module.

14. The method in accordance with claim 13, further comprising a step of transmitting an acknowledgement message to said local exchange by said main interface system to maintain connective communication between said local exchange and said network device when said main interface system stays normally, and by said backup interface system when said main interface system fails, after said backup counting module finishes timing thereof.
